(19) United States
(12) Patent Application Publication
(10) Pub. No.: US 2012/0223027 A1
(43) Pub. Date: Sep. 6, 2012

(54) TUBE AND FLOAT SYSTEMS

(76) Inventor: Jonathan Lundt, Seattle, WA (US)

(21) Appl. No.: 13/368,527

(22) Filed: Feb. 8, 2012

Related U.S. Application Data
(60) Provisional application No. 61/448,277, filed on Mar. 2, 2011.

(51) Int. Cl. B01D 21/26

(52) U.S. Cl. 210/789; 210/521

(57) ABSTRACT

Tube and float systems described herein facilitate removal of certain non-target materials in order to further isolation and extraction of a target material. The tube includes a re-sealable plug located in the base of the tube opposite the tube opening. The float is selected with a specific gravity to substantially match the specific gravity of the target material. When the tube, float and suspension are centrifuged for a period of time, the various materials separate into different layers along the axis of the tube according to specific gravity of each material. The plug located in the base of the tube enables non-target material layers located beneath the float to be extracted, which facilitates isolation and extraction of the target material located between the float and inner wall of the tube. The plug also allows other liquids to be injected into the tube from below the float.

### CROSS-REFERENCE TO RELATED APPLICATION

This application claims the benefit of Provisional Application No. 61/448,277, tiled Mar. 2, 2011.

### TECHNICAL FIELD

This disclosure is directed to suspensions and, in particular, to systems and methods for isolating target particles of a suspension.

### BACKGROUND

A suspension is a fluid containing various materials composed of particles that are sufficiently large for sedimentation. Examples of suspensions include paint, urine, anticoagulated whole blood, and other naturally occurring, manufactured of bodily fluids. The various materials of a suspension can be separated by placing the suspension in a tube and centrifuging the tube and suspension to separate the materials along the axis of the tube according to the specific gravity of each material. Although centrifugation can be used to separate the various materials, isolating a sought after or target material after centrifugation can be difficult because the suspension may contain layers of non-target materials located above and below the target material layer. To complicate matters further, particles of the target material may occur in such a low concentration that the target particles cannot be practically extracted. For these reasons, practitioners, researchers, and those who desire to isolate and extract low-concentration target materials of a suspension continue to seek systems and methods that enable the target material to be separated from other particles that appear in higher concentrations in the same suspension.

### SUMMARY

Tube and float systems described herein facilitate removal of certain non-target materials in order to further isolation and extraction of a target material. A suspension believed to contain a target material is added to a tube and float system. The tube includes a re-sealable plug located in the base of the tube opposite the tube opening. The float is selected with a specific gravity to substantially match the specific gravity of the target material. When the tube, float and suspension are centrifuged for a period of time, the various materials separate into different layers along the axis of the tube according to the specific gravity of each material. The float is ideally positioned at approximately the same level as a layer containing the target material to axially spread the target material between the outer surface of the float and inner wall of the tube with other non-target materials located in the layers above and below the float. The plug located in the base of the tube enables non-target material layers located beneath the float to be extracted, which facilitates isolation and extraction of the target material located between the float and inner wall of the tube. The plug also allows other liquids to be injected into the tube from below the float.

### DESCRIPTION OF THE DRAWINGS

FIG. 1A shows an isometric view of an example tube and float system.

FIGS. 1B-1C show two different cross-sectional views of a closed end of an example tube and float system.

FIGS. 2A-2B show cross-sectional views of two example closed end configurations for a tube of a tube and float system.

FIG. 3A shows an isometric view of an example tube and float system.

FIGS. 3B-3C show cross-sectional views of a closed end of an example tube and float system.

FIG. 4A shows an isometric view of an example tube and float system.

FIG. 4B shows a cross-sectional view of a closed end of an example tube and float system.

FIG. 4C shows a bottom view of the closed end.

FIGS. 5-8 show examples of different types of floats.

FIGS. 9A-9E show an example method of isolating target materials of a suspension using a tube and float system.

### DETAILED DESCRIPTION

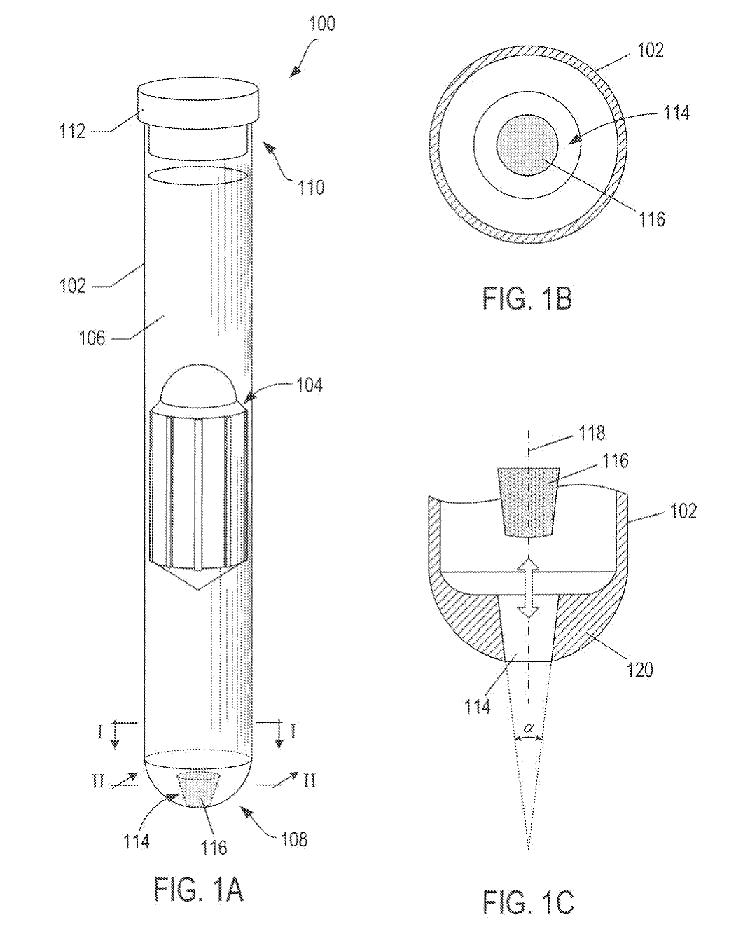

FIG. 1A shows an isometric view of an example tube and float system 100. The system 100 includes a tube 102 and a float 104 suspended in a suspension 106. In the example of FIG. 1A, the tube 102 has a circular cross-section, a closed end 108, and an open end 110. The open end 110 is sized to receive a stopper or cap 112 and may also be threaded (not shown) to receive a threaded stopper or screw cap 112 that can be screwed onto the open end 110. FIG. 1A also reveals that the closed end 108 includes an opening 114 and a plug 116 that fills the opening 114. FIGS. 1B-1C show two different cross-sectional views of the closed end 108. FIG. 1B shows a cross-sectional view of the closed end 108 along a line I-I, shown in FIG. 1A. FIG. 1B reveals that the opening 114 and plug 116 are circular. FIG. 1C shows a cross-sectional view of the closed end 108 along the line II-II, shown in FIG. 1A, with the plug 116 removed from the opening 114. FIG. 1C reveals that the opening 114 is located along the cylindrical axis 118 of the tube 102. The base 120 of the tube is thicker than the sidewalls of the tube 102 in order to form sidewalls for the opening 114′. In the example of FIGS. 1A-1C, the opening 114 has the shape of a conical frustum with the narrow end of the opening 114 located in the exterior surface at the base 120 of the tube 102 and the wide end of the opening 114 located in the bottom of the tube 102 interior. The plug 116 has a conical frustum-like shape in that one end is planar while the opposite end is curved to substantially match the semicircular outer surface of the closed end 108. The plug 116 is dimensioned to fit tightly within the opening 114 and can be held in place with an adhesive. The conical angle, α, of the opening 114 and plug 116 can range from about 10° to about 20°.

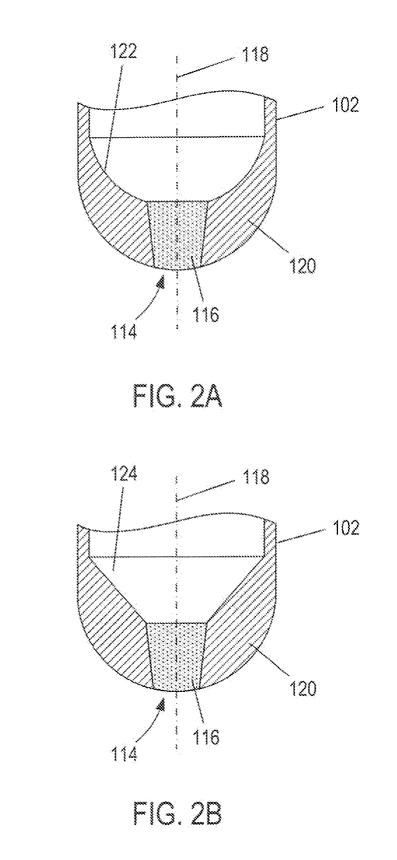

As shown in the cross-sectional view of FIG. 1C, the bottom of the tube 102 interior is substantially flat around the opening 114. In alternate embodiments, the bottom of the tube 102 interior can be angled toward the opening 114 to direct liquid contents in the tube 102 toward the opening 114. FIGS. 2A-2B show cross-sectional views of two example configurations for the closed end 108 of the tube 102 along the line II-II, shown in FIG. 1A. In FIG. 2A, the tube 102 includes a hemispherical or parabolically-shaped taper 122 toward the opening 114. In FIG. 2B, the tube 102 includes a conically-shaped taper 124 toward the opening 114. The parabolically and conically-shaped tapers formed in the interior bottom of the tube 102 operate as a funnel to direct the flow of liquid contents located beneath the float 104 to the opening 114.

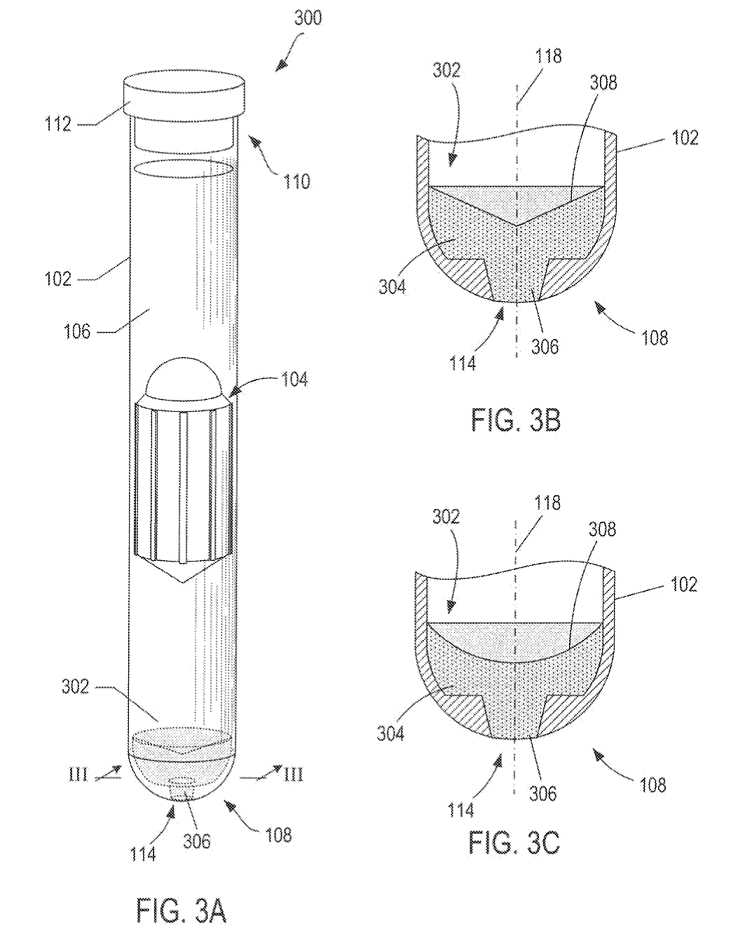

The plug is not limited to simply filling an opening in the base of the tube 102. FIG. 3A shows an isometric view of an example tube and float system 300. The system 300 is similar to the system 100 except the system 300 includes a plug 302 composed of a funnel 304 that substantially fills the bottom of the tube 102 interior and a protuberance 306 with conical frustum-like shape that fills the opening 114. FIGS. 3B-3C show cross-sectional views of the closed end 108 along a line shown in FIG. 3A, for two different types of plugs. In the example of FIG. 3B, the funnel 304 is conically tapered 308 toward the cylindrical axis 118 and the protuberance 306 has a conical frustum-like shape to fill the opening 114. In the example of FIG. 3C, the funnel 304 is parabolically tapered 310 with the parabolic taper minimum located near the cylindrical axis 118.

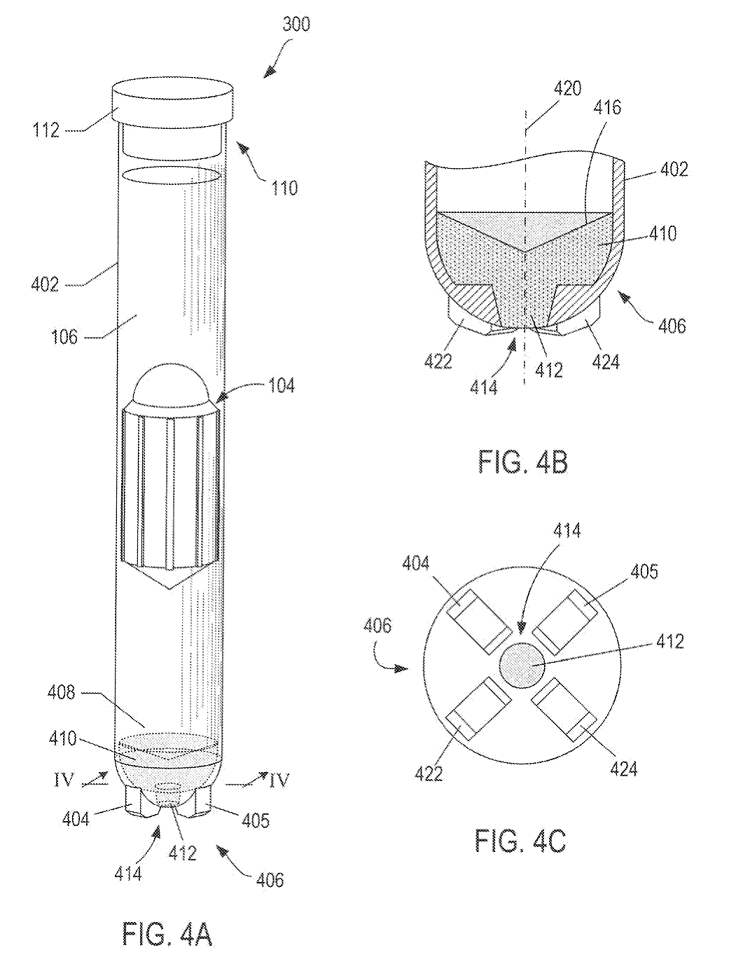

A tube of a tube and float systems described above may include a number of feet, which are protuberances located around the base of the closed end 108 to enable the systems to stand on the closed end 108 and allow the tube to engage the protuberances of a tube rotating device that axially rotates the tube. FIG. 4A shows an isometric view of an example tube and float system 400. The system 400 is similar to the system 300 except the tube 102 is replaced by a tube 402 with feet, such as feet 404 and 405, located around the base of the closed end 406 of the tube 402. Like the system 300, the system 400 includes a plug 408 composed of a funnel 410 and a conical frustum-like shaped protuberance 412 that fills an opening 414 in the closed end 406. FIG. 4B shows a cross-sectional view of the closed end 406 along a line IV-IV, shown in FIG. 4A. The plug 408 includes a conically tapered funnel 416. The opening 414 is located along the cylindrical axis 420 of the tube 402 and is in the shape of a conical frustum to receive the protuberance 412. FIG. 4C shows a bottom view of the closed end 406. The tube 402 includes four feet 404, 405, 422 and 424 located at the closed end 406 and distributed around the opening 414.

The tubes of the tube and float systems described above can be composed of a transparent or semitransparent flexible material, such as plastic. The plugs are composed of re-sealable rubber or other suitable re-sealable material that can be repeatedly punctured with a needle or other sharp implement to access the contents stored in the tube 102 interior and re-seals when the needle or implement is removed. The plugs can be formed in the openings and/or the bottom interior of the tube using heated liquid rubber that can be shaped and hardens as the rubber cools. The adhesive used to attach a plug to the wall of the opening and tube interior and can be a polymer-based adhesive, an epoxy, a contact adhesives or any other suitable material for bonding rubber to plastic.

The tubes of the tube and float systems described above have a generally cylindrical geometry, but may also have a tapered geometry that widens toward the open end and narrows toward the closed end. Although the tubes have a circular cross-section, in other embodiments, a tube can have elliptical, square, triangular, rectangular, octagonal, or any other suitable cross-sectional shape that substantially spans the length of the tube. The openings in the closed ends of the tubes are not intended to be limited to conical frustum shapes with circular bases. In alternative embodiments, an opening can be a frustum with triangular, square, pentagonal, hexagonal, or any other suitable or irregularly shaped base and the plug can be dimensioned to fit tightly within the opening. As shown in FIGS. 1-4, the base of each plug is rounded to be flush with the semicircular profile of the closed end of the tube. In alternative embodiments, the base can be flat and/or the length of the plug does not span the entire length of the opening, but instead, the plug may Only partially penetrate the opening by any length.

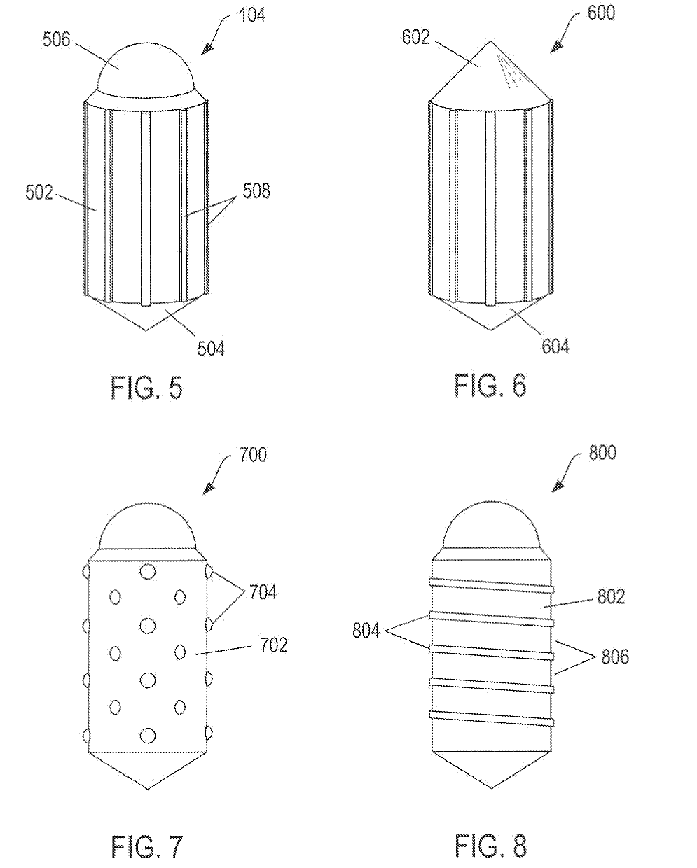

FIG. 5 shows an isometric view of the float 104 shown in FIGS. 1-4. The float 104 includes a main body 502, a cone-shaped tapered end 504, a dome-shaped end 506, and radially spaced and axially oriented splines 508 on the main body 502. The splines 508 provide a sealing engagement with the inner wall of the tube. In alternative embodiments, the number of splines, spline spacing, and spline thickness parameters can each be varied. The splines 508 can also be broken or segmented. The main body 502 is sized to have an outer diameter that is less than the inner diameter of the tube 102, in order to form fluid retention channels between the body 502 and the inner wall of the tube 102. The surfaces of the main body 502 between the splines 508 can be flat, curved or have another suitable geometry. In the example of FIG. 5, the splines 508 and the main body 502 form a single structure.

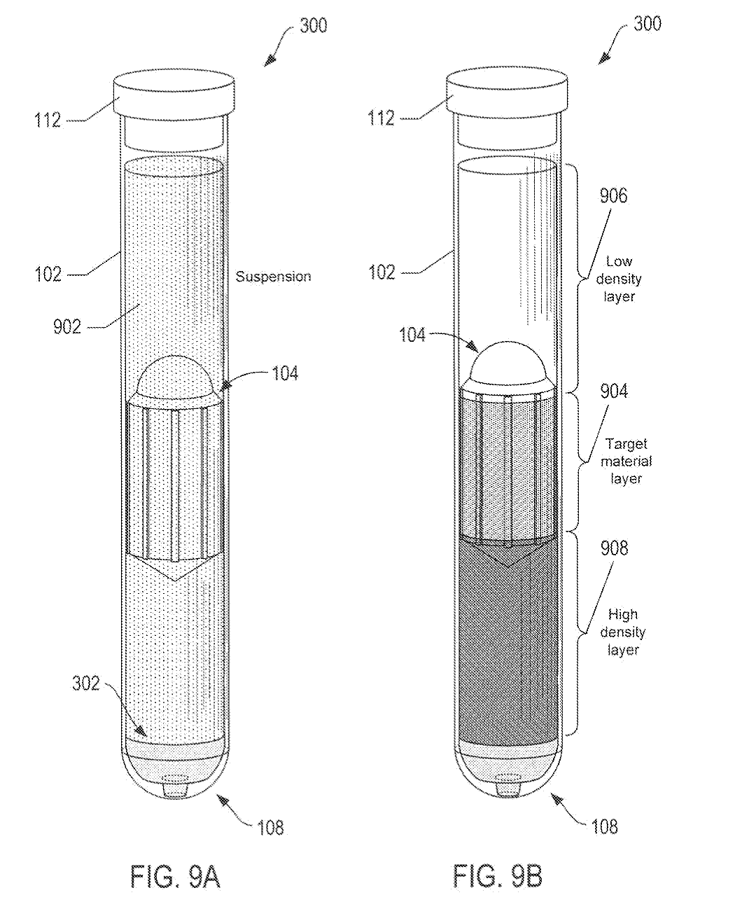

Embodiments include other types of geometric shapes for float end caps. FIG. 6 shows an isometric view of an example float 600 with two cone-shaped end caps 602 and 604. The main body 606 of the float 600 includes the same structural elements (i.e., splines) as the float 104. A float can also include two dome-shaped end caps.

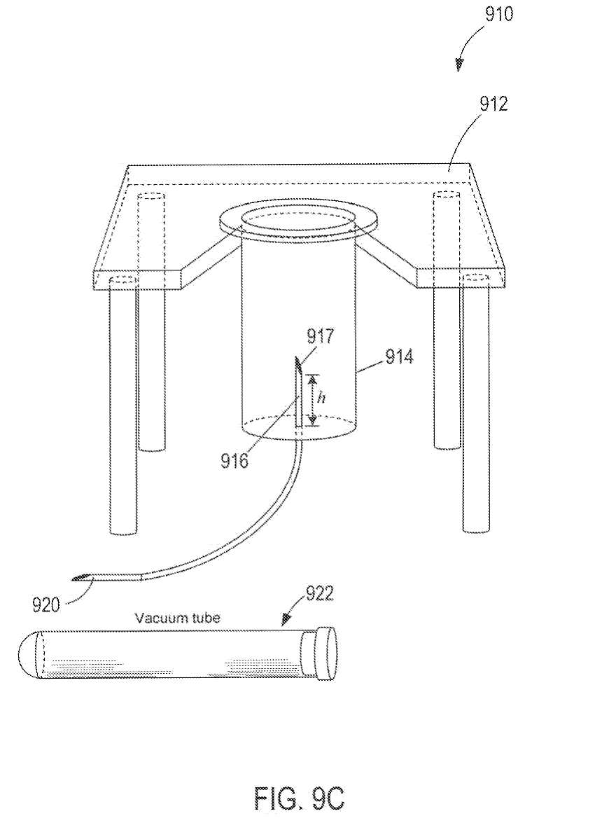

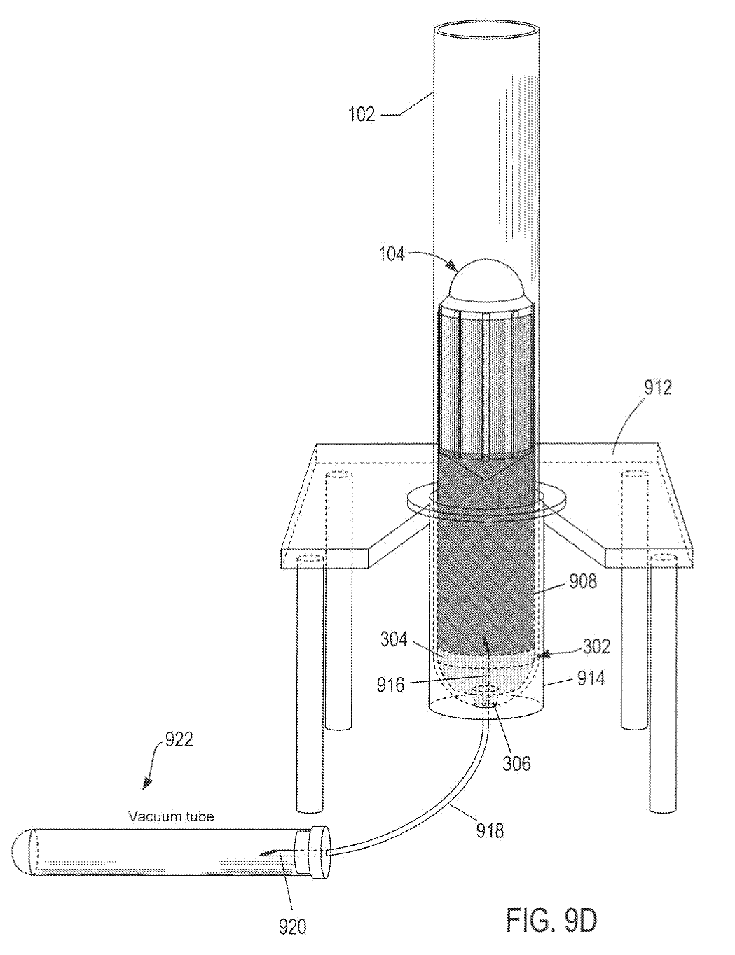

In other embodiments, the main body of the float 104 can include a variety of different support structures for separating target materials, supporting the tube wall, or directing the suspension fluid around the float during centrifugation. FIGS. 7-8 show two examples of main body structural elements. In FIG. 7, the main body 702 of a float 700 is similar to the float 104 except the main body 702 includes a number of protrusions 704 that provide support for the deformable tube. In alternative embodiments, the number and pattern of protrusions can be varied. In FIG. 8, the main body 802 of a float 800 includes a single continuous helical structure or ridge 804 that spirals around the main body 802 creating a helical channel 806. In other embodiments, the helical ridge 804 can be rounded or broken or segmented to allow fluid to flow between adjacent turns of the helical ridge 804. In various embodiments, the helical ridge spacing and rib thickness can be independently varied.

A float can be composed of a variety of different materials including, but are not limited to, rigid organic or inorganic materials, and rigid plastic materials, such as polyoxymethylene (“Delrin®”), polystyrene, acrylonitrile butadiene styrene (“ABS”) copolymers, aromatic polycarbonates, aromatic polyesters, carboxymethylcellulose, ethyl cellulose, ethylene vinyl acetate copolymers, nylon, polyacetals, polyacetates, polyacrylonitrile and other nitrile resins, polyacrylonitrile-vinyl chloride copolymer, polyamides, aromatic polyamides (“aramids”), polyamide-imide, polyarylates, polyarylene oxides, polyarylene sulfides, polyarylsulfones, polybenzimidazole, polybutylene terephthalate, polycarbonates, polyester, polyester imides, polyether sulfones, polyetherimides, polyetherketones, polyetheretherketoncs, polyethylene terephthalate, polyimides, polymethacrylate, polyolefins (e.g., polyethylene, polypropylene), polyallomers, polyoxadiazole, polyparaxylene, polyphenylene oxides (PPO), modified PPOs, polystyrene, polysulfone, fluorine containing polymer such as polytetrafluoroethylene, polyurethane, polyvinyl acetate, polyvinyl alcohol, polyvinyl halides such as polyvinyl chloride, polyvinyl chloride-vinyl acetate copolymer, polyvinyl pyrrolidone, polyvinylidene chloride, specialty polymers, polystyrene, polycarbonate, polypropylene, acrylonitrite butadiene-styrene copolymer and others.

The surface of the main body of a float can be coated with a material that attaches target material particles to the surface of the main body of the float. For example, the coating can generate attractive electrostatic forces with a net charge that is opposite the net charge of the target material particles. As a result, the target particles attach to the main body surface via attractive electrostatic forces.

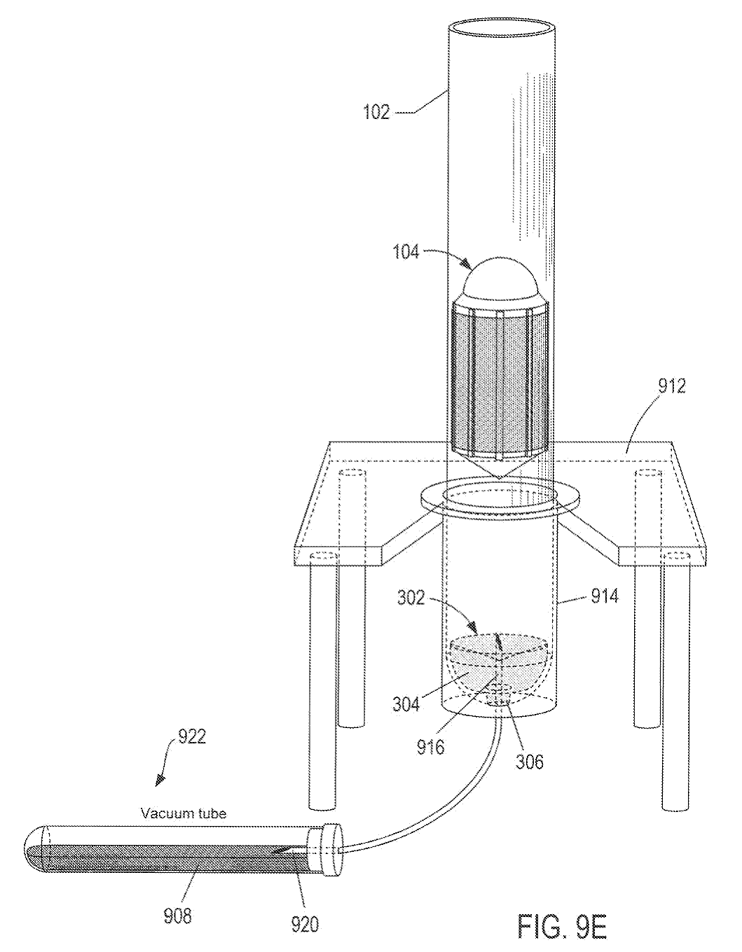

Methods for using the tube and float systems to isolate a target material of a suspension are now described. Although the following method is described with reference to one of the tube and float systems described, any one of the tube and float systems described above can be used in the same manner to achieve isolation and extraction of a target material. FIG. 9A shows an example of the tube and float system 300 with the tube 102 filled with a suspension 902 suspected of containing a target material. The float 104 is selected to have a specific gravity that substantially matches the specific gravity of the target materials. The main body of the float 104 may also he coated with a material to attach any target particles to the main body of the float 104. The float 104 can be inserted prior to or after the suspension is drawn into the tube 102. The tube 102, float 104 and suspension 902 are centrifuged for a period of time sufficient to enable materials in the suspension to separate according to their associated specific gravities. FIG. 9B shows an example representation of the system 300 after centrifugation. In the example of FIG. 9B, the materials in the suspension are separated into three distinct layers identified as a target material layer 904 spread between the main body of the float 104 and inner wall of the tube 102, a low-density layer 906 located above the float 104, and a high-density layer 908 located beneath the float 104. Centrifugation cause materials composed of particles with a relatively higher specific gravity than the target materials to migrate to the region beneath the float 104 while materials composed of particles with a relatively lower specific gravity than the target materials to migrate to the low-density layer 906.

When the target material is present, the target particles should be attached to the main body of the float 104 and the target particles may be detected through the wall of the tube 102. On the one hand, when no target particles are detected between the main body of the float 104 and inner wall of the tube 102, no further processing may be required and the method stops. On the other hand, when target particles are detected and further isolation of the target material is desired, the cap 112 can be removed and the low-density layer 906 and liquid in the target material 904 can be poured off or aspirated with a pipette.

FIG. 9C shows an example of a system 910 for extracting the high-density layer 906. The system 910 includes a stand 912 notched to receive a tube holder 914. The holder 914 has an open end dimensioned to receive the tube 102, and a first needle 916 with the beveled end directed into the cavity of the holder 914. The length of the needle 916 from the bottom of the holder 914 to the bottom of the needle opening 917 may be approximately equal to the distance from the bottom of the tube 102 to the apex of the funnel 304. A flexible tube 918 is connected at a first end to the needle 916 and is connected at a second end to a second needle 920. The system 910 also includes a vacuum tube 922.

As shown in FIGS. 9D, the tube 102 is inserted into the cavity of the holder 914 so that the first needle 916 punctures the plug 302. As described above, the plug 302 is composed of a rubber that enables the needle 916 to pass through while forming a liquid-tight seal around the first needle 916 to prevent the liquid contents from leaking around the needle 916. The first needle 916 passes through the protrusion 306 with the hole 917 located, within the high-density layer 908 and near the apex of the funnel 304. The second needle 920 is then inserted into the vacuum tube 922. Vacuum pressure then causes the high-density material 908 and other materials and fluids trapped below the float 104 to be drawn through the tube 918 into the vacuum tube 922 as air is drawn into the tube 102 between the main body of the float 104 and the inner wall of the tube 102. FIG. 9E shows the high-density material 908 and other materials and fluids trapped below the float 104 are drawn into the vacuum tube 922. As the high-density material draws down, the funnel 304 portion of the plug 302 directs the remaining contents of the material to the hole 917 of the needle 916. When the needle 916 is removed, the opening in the plug 302 created by the needle 916 closes to form a liquid-tight seal.

Note that the plug also allows other liquids, such as a wash, to be injected into the tube 102 from below the float 104.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the following claims and their equivalents:

1. A system for isolating a target material of a suspension comprising:
a float; and
a tube with an open end and a closed end, the tube dimensioned to receive the float and the closed end includes an opening and a re-sealable plug that fills the opening, wherein the plug forms a liquid-tight seal around an instrument to be inserted into the tube through the plug and closes to form a liquid-tight seal when the instrument is removed.

2. The system of claim 1, wherein the tube interior is conically tapered around the opening to form a funnel.

3. The system of claim 1, wherein the tube interior is parabolically tapered around the opening to form a funnel.

4. The system of claim 1, wherein the plug includes a conically tapered funnel that occupies the base of the tube interior and a protuberance that fills the opening.

5. The system of claim 1, wherein the plug includes a parabolically tapered funnel that occupies the base of the tube interior and a protuberance that fills the opening.

6. The system of claim 1, wherein the plug is adhered to the tube.

7. The system of claim 1, wherein the base of the plug is rounded to be flush with the semicircular outer surface of the closed end of the tube.

8. A method for isolating at least one target material of a suspension, the method comprising:
centrifuging the suspension in a tube and float system, wherein the tube includes an open end and a closed end, wherein the closed end includes an opening and a re-sealable plug that fills the opening;
removing non-target material layers located above the float;
inserting a needle through the plug and into the tube; and
removing non-target material layers located beneath the float by drawing the materials through the needle.

9. The method of claim 8, wherein removing non-target material layers located above the float further comprises pipetting the non-target material layers off.

10. The method of claim 8, wherein removing non-target material layers located beneath the float by drawing the materials through the needle further comprises drawing the non-target materials through the needle applying vacuum pressure.

11. The method of claim 8, wherein the tube interior is conically tapered around the opening to form a funnel.

12. The method of claim 8, wherein the tube interior is parabolically tapered around the opening to form a funnel.

13. The method of claim 8, wherein the plug includes a conically tapered funnel that occupies the base of the tube interior and a protuberance that fills the opening.
